(19) United States
(12) Patent Application Publication
(10) Pub. No.: US 2016/0234554 A1
(43) Pub. Date: Aug. 11, 2016

(54) RENEWABLE CONDITIONAL ACCESS SYSTEM AND REQUEST PROCESSING METHOD FOR THE SAME

(71) Applicant: ELECTRONICS AND TELECOMMUNICATIONS RESEARCH INSTITUTE, Daejeon (KR)

(72) Inventor: Han-Seung KOO, Daejeon (KR)

(73) Assignee: ELECTRONICS AND TELECOMMUNICATIONS RESEARCH INSTITUTE, Daejeon (KR)

(21) Appl. No.: 15/005,124

(22) Filed: Jan. 25, 2016

(30) Foreign Application Priority Data
Feb. 5, 2015 (KR) 10-2015-0017834
Sep. 30, 2015 (KR) 10-2015-0137293

(51) Int. Cl. H04N 21/4627; H04N 21/8352

(52) U.S. Cl. CPC H04N 21/4627; H04N 21/8352

(57) ABSTRACT

Disclosed herein are an RCAS and a request processing method for the RCAS. The request processing method according to an embodiment includes validating, by a Distributed Authorization Center (DAC), a join request or a leave request transmitted from a Set-Top Box (STB), sending, by the DAC, a report message to a Centralized Authorization Center (CAC) when validation has succeeded, updating, by the CAC, a database (DB) related to a state of the STB, based on the report message, and sending a certificate state update message including information about the update to DACs of one or more additional head-ends.

### CROSS REFERENCE TO RELATED APPLICATION

This application claims the benefit of Korean Patent Application Nos. 10-2015-0017834, filed Feb. 5, 2015 and 10-2015-0137293, filed Sep. 30, 2015, which are hereby incorporated by reference in their entirety into this application.

### BACKGROUND OF THE INVENTION

1. Technical Field

The present invention generally relates to technology for an interface that processes requests in a Renewable Conditional Access System (RCAS) and, more particularly, to technology for processing an interface between a Distributed Authorization Center (DAC) and a Centralized Authorization Center (CAC).

2. Description of the Related Art

Recently, the International Telecommunication Union Telecommunication Standardization Sector (ITU-T) has developed Renewable Conditional Access System (RCAS) network protocols that enable Conditional Access Client Software (CACS) for digital cable broadcasting to be remotely renewed.

As one of technologies related to conditional access systems, there is Korean Patent No. 10-0835984 (Date of Registration: Jun. 2, 2008) entitled “Method and Apparatus for upgrading of limited reception system in digital cable broadcasting”. This patent discloses technology in which, when a conditional access system renewal message is received from a head-end, a conditional access system renewal request message is sent to a set-top box, and in which, when a system renewal acknowledgement message is received from the set-top box, a system renewal program is received from the head-end and is then applied, after which the application thereof is reported to the set-top box and the head-end.

However, the RCAS network protocol, which is currently under development, defines only a message structure, but does not define content to be inserted into the payload of a message.

Therefore, considering the current trend, in which RCAS networks are gradually coming to be used in an increasing variety of fields, such as for Internet Protocol Television (IPTV), there is a growing need to define message structures in messages that are used in the RCAS network protocol.

### SUMMARY OF THE INVENTION

Accordingly, the present invention has been made keeping in mind the above problems occurring in the prior art, and an object of the present invention is to define content to be inserted into the payload of a message in an Abstract Syntax Notation One (ASN.1) format, in messages delivered between a DAC and a CAC in an RCAS.

Another object of the present invention is to efficiently operate an RCAS using messages delivered between a DAC and a CAC that are defined in the present invention.

In accordance with an aspect of the present invention to accomplish the above objects, there is provided a request processing method for a Renewable Conditional Access System (RCAS) including head-ends, including validating, by a Distributed Authorization Center (DAC), a join request or a leave request transmitted from a Set-Top Box (STB); sending, by the DAC, a report message to a Centralized Authorization Center (CAC) when validation has succeeded; updating, by the CAC, a database (DB) related to a state of the STB, based on the report message; and sending a certificate state update message including information about the update to DACs of one or more additional head-ends.

Sending the report message to the CAC may include sending a report message to the CAC when the join request is successfully validated, the report message including a DAC identifier of the DAC, a Conditional Access Module Sub-system (CASS) identifier of a CASS, a Conditional Access Module (CAM) identifier of a CAM of the STB, and a descrambler identifier of a descrambler of the STB.

The request processing method may further include sending, by the CAC, an acknowledgement message, in response to the report message, to the DAC.

The acknowledgement message may include data about a result of processing the join request by the CAC, based on the report message for the join request.

Sending the report message to the CAC may include sending a report message to the CAC when the leave request is successfully validated, the report message including a DAC identifier of the DAC, a CASS identifier of a CASS, a CAM identifier of a CAM of the STB, and a descrambler identifier of a descrambler of the STB.

The request processing method may further include sending, by the CAC, an acknowledgement message for the leave request to the DAC.

The acknowledgement message for the leave request may include data about a result of processing the leave request by the CAC, based on the report message for the leave request.

The information about the update may include at least one parameter that includes an update query of the database.

The request processing method may further include synchronizing, by the DAC, information about the STB with the CAC, based on the certificate state update message.

The request processing method may further include sending, by the DAC, an acknowledgement message including a result of synchronization to the CAC.

In accordance with another aspect of the present invention to accomplish the above objects, there is provided a request processing method for a Renewable Conditional Access System (RCAS) including head-ends, including requesting, by a Distributed Authorization Center (DAC), a Centralized Authorization Center (CAC) to generate a certificate of a Set-Top Box (STB); and generating, by the CAC, the certificate, and sending both the certificate and a message including information about the certificate to the DAC.

The message including information about the certificate may include at least one of information about whether there is an additional certificate to be transmitted from the CAC to the DAC, information about a path of a folder in which certificates are stored, a length of each certificate, and a file name of the certificate.

The request processing method may further include sending, by the DAC, an acknowledgement message including a result of transmitting the certificate to the CAC, based on the message including the information about the certificate.

Sending the acknowledgement message to the CAC may include determining, by the CAC, whether transmission of the certificate has been completed, based on information about whether there is an additional certificate to be transmitted to the DAC, and sending the acknowledgement message to the CAC if it is determined that the transmission of the certificate has been completed.

In accordance with a further aspect of the present invention to accomplish the above objects, there is provided a Renewable Conditional Access System (RCAS) including head-ends, including a Distributed Authorization Center (DAC) for validating a join request or a leave request transmitted from a Set Top Box (STB), and sending a report message to a Centralized Authorization Center (CAC) when validation has succeeded; and the CAC for updating a database related to a state of the STB, based on the report message, and sending a certificate state update message including information about the update to DACs of one or more additional head-ends.

The DAC may send a report message to the CAC when the join request is successfully validated, the report message including a DAC identifier of the DAC, a Conditional Access Module Sub-system (CASS) identifier of a CASS, a CAM identifier of a CAM of the STB, and a descrambler identifier of a descrambler of the STB.

The CAC may send an acknowledge message, in response to the report message, to the DAC.

The CAC may send the acknowledgement message including data obtained by processing the join request based on the report message for the join request.

Each of the report message and the acknowledgement message may be defined in an Abstract Syntax Notation One (ASN.1) syntax format.

The report message and the acknowledgement message may have different message type values depending on names of the messages and directions in which the messages are sent.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a Renewable Conditional Access System (RCAS) according to an embodiment of the present invention;

FIG. 2 is a block diagram showing a head-end in the RCAS according to an embodiment of the present invention;

FIG. 3 is a diagram showing a message structure used in the RCAS according to an embodiment of the present invention;

FIG. 4 is a block diagram showing a CAC and a DAC in the RCAS according to an embodiment of the present invention;

FIGS. 5 to 13 are diagrams showing the types of messages used in the RCAS according to an embodiment of the present invention; and

FIG. 14 is an operation flowchart showing a request processing method for the RCAS according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

First, the terms and abbreviations used in the present specification are defined.

The term “conditional access” means that access to cable service and content is conditionally approved.

The term “scrambling” means the procedure in which sound, an image, or the like is encrypted to prevent an unauthorized group, user, or the like from using the sound or the image.

The term “descrambling” means the procedure in which the scrambled, i.e. encrypted, data, sound, or image is restored to an accessible format using a reverse scrambling function.

The term “Entitlement Control Message (ECM)” means information including access criteria required to access encrypted control words and various services.

The term “Entitlement Management Message (EMM)” means information obtained by encrypting and sending reception entitlement information.

The abbreviation for “conditional access client software” is “CACS”.

The abbreviation for “conditional access module” is “CAM”.

The abbreviation for “conditional access module sub-system” is “CASS”.

The abbreviation for “distributed authorization center” is “DAC”.

The abbreviation for “renewable conditional access system” is “RCAS”.

The abbreviation for “secure CACS download sub-system” is “SCDSS”.

Hereinafter, preferred embodiments of the present invention will be described in detail with reference to the attached drawings.

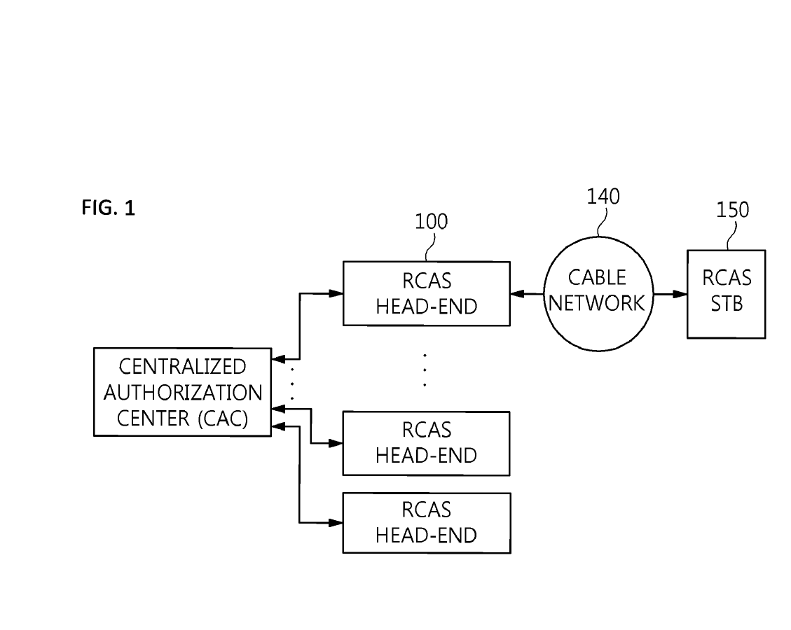

FIG. 1 is a block diagram showing an RCAS according to an embodiment of the present invention.

The RCAS includes a Centralized Authorization Center (CAC), RCAS head-ends 100, and a set-top box (STB) 150 connected to individual RCAS head-ends.

Here, a Conditional Access System (CAS) denotes a system for allowing a digital receiver (e.g. an STB or the like) to determine whether a specific broadcast program can be received.

The CAS includes technology for renewing CACS, and uses a scheme for securely downloading new CACS through a two-way digital cable.

That is, the CAS refers to a system that allows only a user who has been authorized for reception by paying legitimate license fees to view the corresponding program.

Here, the CAS may transfer a private key to the STB using a smart card containing unique personal information or the like of a subscriber.

Here, the STB, having received the private key, enables a specific broadcast program to be viewed using the private key.

Each of the head-ends 100 includes a Distributed Authorization Center (DAC), a Conditional Access module Sub-System (CASS), and a Secure CACS Download Sub-System (SCDSS).

Here, as the head-end 100, multiple head-ends may be present for a single CAC because it is impossible to cover the entire service area using only a single head-end 100.

That is, a single DAC is present in each of the head-ends 100, and multiple DACs are connected to a single CAC.

The reason for this is to efficiently control the authorization procedure for multiple STBs.

As shown in FIG. 1, multiple service providers (Multiple Service Operators: MSOs) share a single CAC with each other, and each of the multiple head-ends has a single DAC.

Therefore, the ratio of the numbers of CACs to DACs is 1:N, whereas the ratio of the numbers of DACs to CASSs is 1:1.

The STB may include a Conditional Access Module (CAM) and a descrambler.

The CAM denotes a PC-card-type electronic device inserted into a subscriber terminal device (e.g. an STB or the like) for conditional access.

Here, the CAM may provide a slot into which a smart card can be inserted.

Here, when scrambled broadcast signals and a control command are delivered to the STB, the CAM may check authority to view the corresponding broadcast signals using a conditional access function present in the smart card.

In this case, the descrambler in the STB may provide a complete video by descrambling scrambled signals.

‘Scrambling’ denotes technology for encoding or encrypting signals using a suitable method, thus preventing unauthorized viewers from understanding the signals. For example, when normal picture signals are encrypted and transmitted with the signals scrambled, unauthorized viewers cannot receive normal picture signals.

When the scrambled picture signals are descrambled, the normal picture signals may be received.

Here, to descramble the scrambled signals, a specific decoder and an encryption key are required. The normal picture may be provided only to specific viewers using a scheme for providing an encryption key only to the specific viewers.

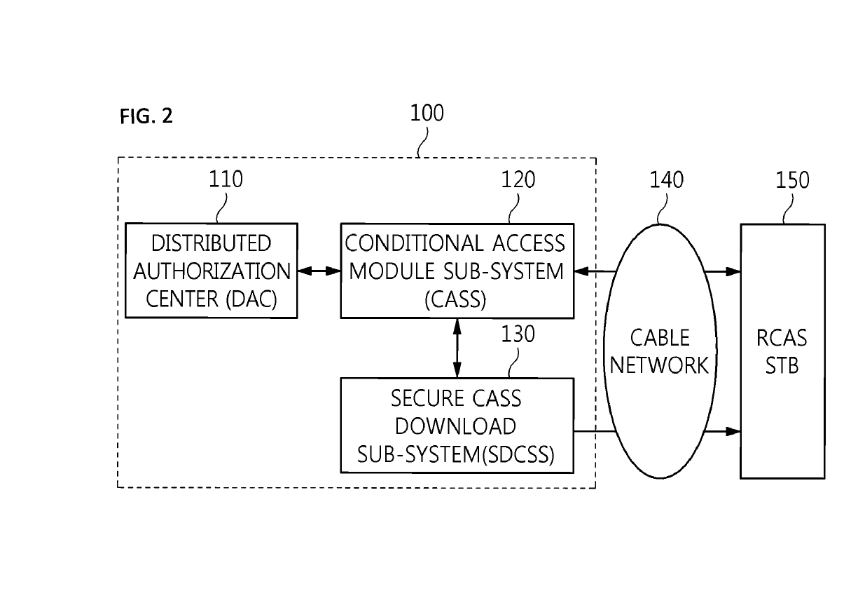

FIG. 2 is a block diagram showing a head-end in the RCAS according to an embodiment of the present invention.

Referring to FIG. 2, an RCAS head-end 100 according to an embodiment of the present invention includes a DAC 110, a CASS 120, and an SCDSS 130, and is connected to an RCAS STB 150 through a cable network 140.

Here, the RCAS head-end 100 is located in a cable broadcasting station.

The CASS 120 functions to establish a security channel between the RCAS STB 150 and the RCAS head-end 100.

Here, the SCDSS 130 functions thereafter to transmit down a conditional access client image to the RCAS STB 150 through the security channel after the security channel between the head-end 100 and the RCAS STB 150 has been established.

The DAC 110 may perform functions such as certificate issuance and management for CAS head-end servers.

The DAC 110 may generate unique identification (ID) for each head-end server.

The DAC 110 may validate and manage pairing between a CAM and a descrambler in the STB.

The DAC 110 may manage parameters required for the authorization of the STB.

The DAC 110 may process join and leave requests of the RCAS STB 150 for retail or lease, received from the CASS 120.

Here, the CAC may process joining and leaving of RCAS-related servers located in head-ends, which are separately present, and the RCAS STB 150.

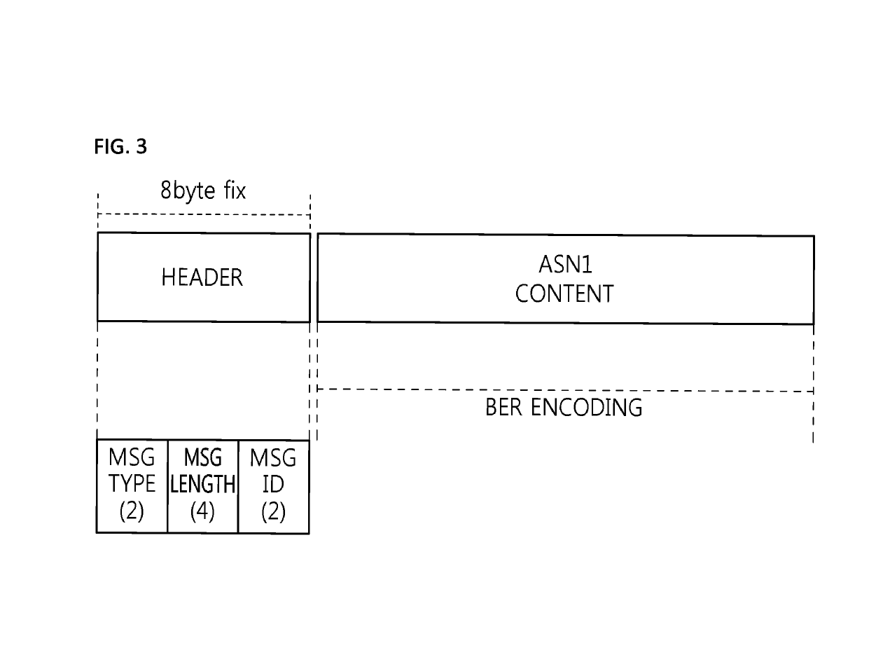

FIG. 3 is a diagram showing a message structure used in the RCAS according to an embodiment of the present invention.

Referring to FIG. 3, interface communication between a CAC and a DAC is performed via the message structure shown in FIG. 3.

Here, a message may be divided into a message header and message content.

Values encoded in an ASN.1 format are inserted into the message content.

‘ASN.1’ denotes a protocol for defining data exchange via the network defined in ITU-T. This belongs to the presentation layer of the seven Open Systems Interconnection (OSI) layers, and is a notation used to describe a data structure.

Currently, the ITU-T Study Group (SG) 9 defines only a message structure, but does not define the content to be inserted into the payload of a message.

That is, the present invention is intended to define content to be inserted into the payload of a message using ASN.1 syntax, which is a protocol description method defined in ITU/ISO/IEC.

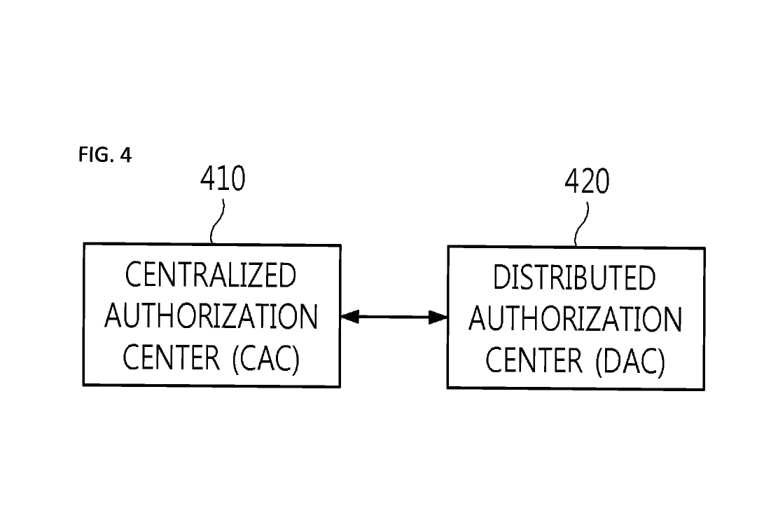

FIG. 4 is a block diagram showing a CAC and a DAC in the RCAS according to an embodiment of the present invention.

A DAC 420 validates a join request or a leave request transmitted from an STB, and sends a report message to the CAC when validation is successfully performed.

Here, as the report message, a report message JOIN_INFO_REPORT, which is sent when the join request is successfully validated, and a report message LEAVE_INFO_REPORT, which is sent when the leave request is successfully validated, may differ from each other.

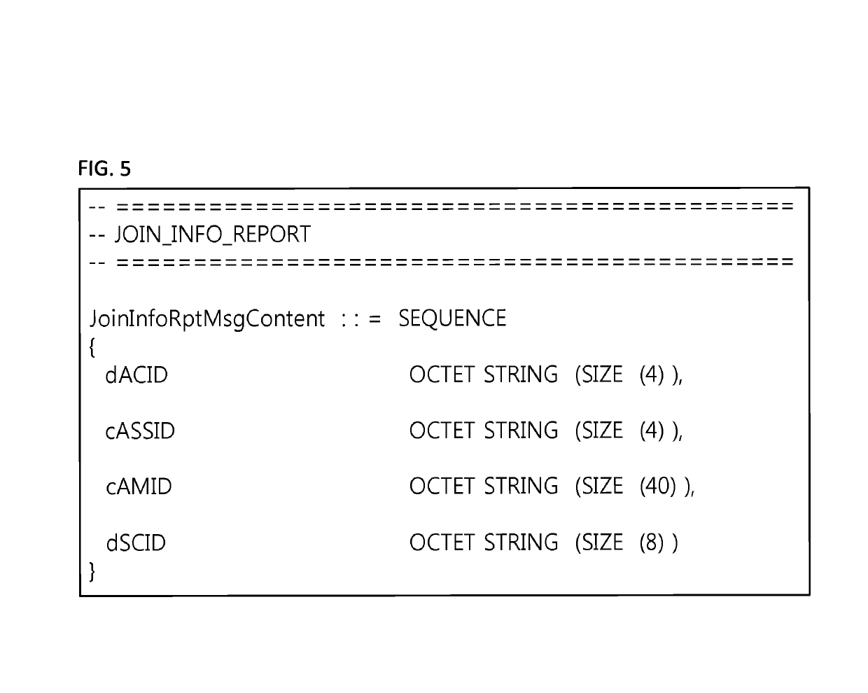

First, the report message JOIN_INFO_REPORT, which is sent when the join request is successfully validated, is illustrated in FIG. 5.

Referring to FIG. 5, it can be seen that the report message includes the identifier of the DAC (DACID), the identifier of the CASS (CASSID), the CAM identifier (CAMID) of the CAM of the STB, and the descrambler ID (DSCID) of the descrambler of the STB.

Here, the CAC 410 may send the DAC 420 an acknowledgement message (ACK) in response to the report message.

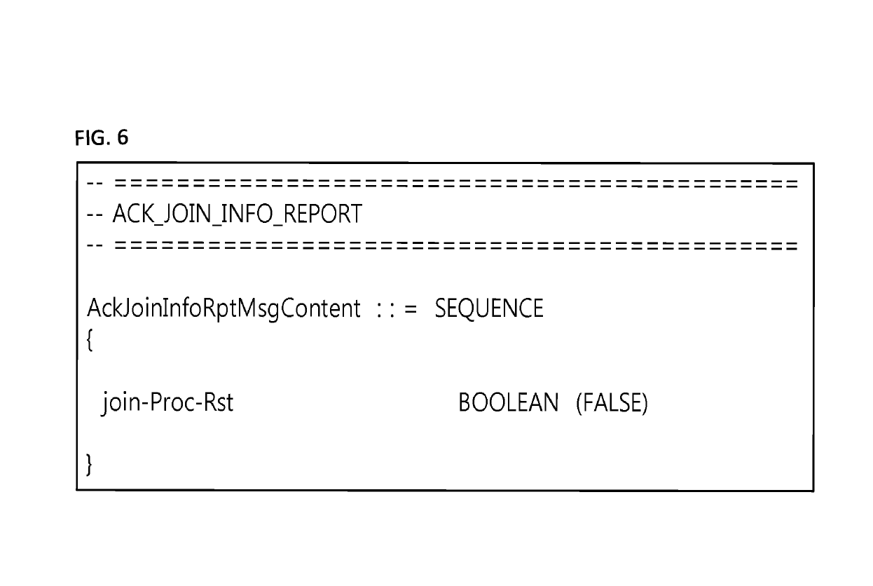

Here, the ACK message ACK_JOIN_INFO_REPORT, which is a response to the report message JOIN_INFO_REPORT, is illustrated in FIG. 6.

Referring to FIG. 6, the ACK message contains data JOIN-PROC-RST about the result of processing the join request using the report message.

The value of JOIN-PROC-RST may be “TRUE” when the join request has succeeded, and may be “FALSE” when the join request has failed.

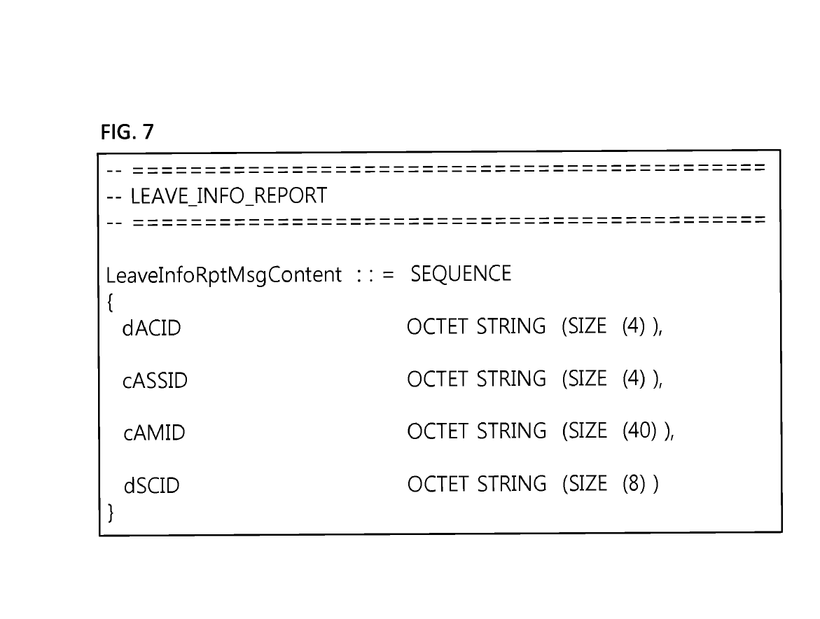

Further, the report message LEAVE_INFO_REPORT, which is sent when the leave request is successfully validated, is illustrated in FIG. 7.

Referring to FIG. 7, it can be seen that the report message may include the identifier of the DAC (DACID), the identifier of the CASS (CASSID), the CAM identifier (CAMID) of the CAM of the STB, and the descrambler ID (DSCID) of the descrambler of the STB.

Here, the CAC 410 may send the DAC 420 an ACK message in response to the report message.

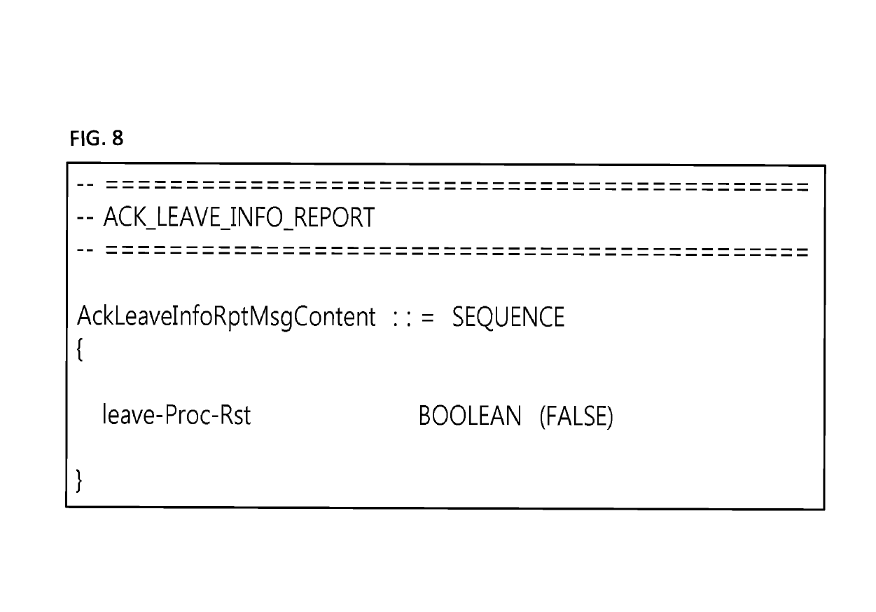

The ACK message, which is a response to the report message, is illustrated in FIG. 8.

Referring to FIG. 8, the ACK message contains data LEAVE-PROC-RST, which indicates the result of processing the leave request using the report message.

The value of LEAVE-PROC-RST may be “TRUE” when the leave request has succeeded, and may be “FALSE” when the leave request has failed.

The CAC 410 updates a DB related to the state of the STB based on the report message, and sends a certificate state update message, which includes information about the update, to the DAC of at least one additional head-end.

That is, when JOIN_INFO_REPORT or LEAVE_INFO_REPORT is received from a specific DAC, the CAC 410 may update its own retail STB state information DB table with the corresponding information, and may transmit the updated information to the DAC of at least one additional head-end so as to synchronize the updated information with other DACs.

Here, information about the update may include at least one parameter.

Here, the at least one parameter may include an update query for the DB.

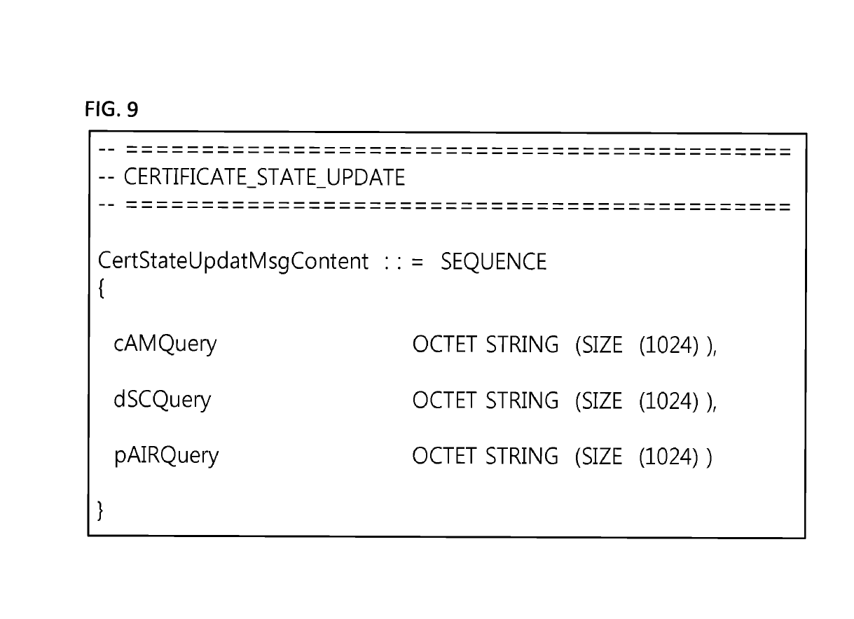

Here, the certificate state information update message CERTIFICATE_STATE_UPDATE is illustrated in FIG. 9.

Referring to FIG. 9, it can be seen that the certificate state information update message includes parameters.

Here, any one of the parameters may correspond to a CAM query.

Any one of the parameters may correspond to a descrambler query DSCQUERY.

Any one of the parameters may correspond to a pair query PAIRQUERY.

The DAC 420 may receive the CERTIFICATE_STATE_UPDATE message from the CAC 410, synchronize the corresponding update information with the CAC, and send an ACK message containing the result of synchronization to the CAC 410.

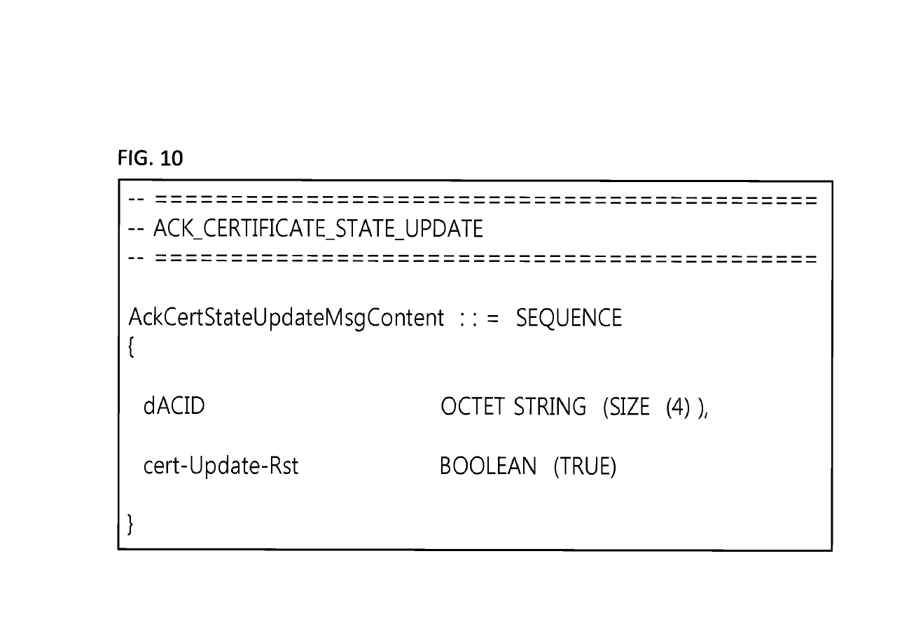

The ACK message containing the result of synchronization is illustrated in FIG. 10.

Referring to FIG. 10, the ACK message containing the result of synchronization includes the identifier of the DAC and the synchronized result CERT_UPDATE_RST.

Here, when synchronization has succeeded, the value of CERT_UPDATE_RST is “TRUE”, whereas when synchronization has failed, the value of CERT_UPDATE_RST is “FALSE”.

Further, the CAC 410 and the DAC 420 may send and receive messages including information about a certificate.

The DAC 420 may request the CAC to generate a certificate.

Here, the CAC 410 may generate the certificate and may transmit both the certificate and a message including information about the certificate to the DAC 420.

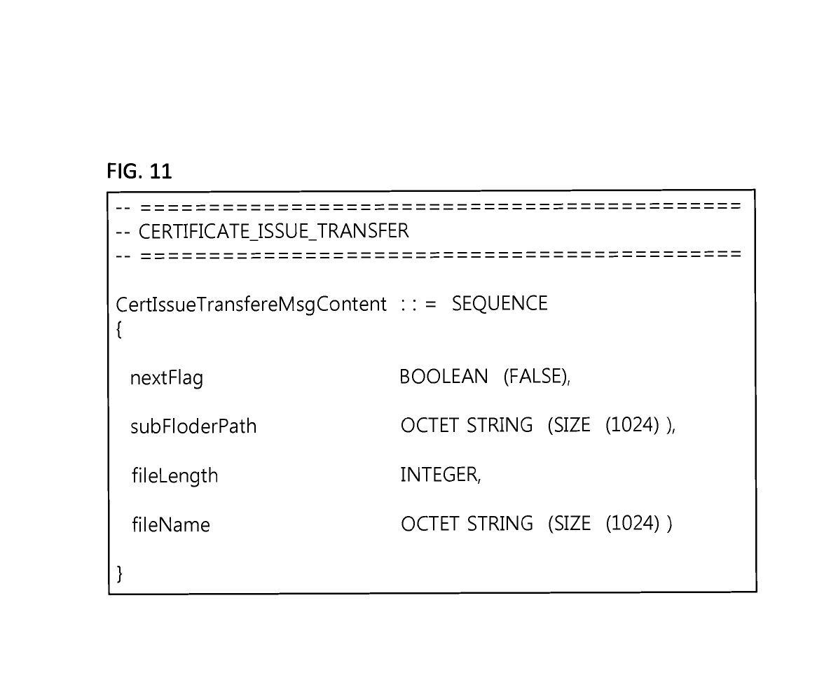

In this regard, the message CERTIFICATE_ISSUE_TRANSFER, which includes information about the certificate, is illustrated in FIG. 11.

Referring to FIG. 11, a flag NEXTFLAG, indicating whether there is an additional certificate to be transmitted, may be included in the message.

In this case, when there is no additional certificate to be transmitted, the NEXTFLAG of the last message is “FALSE”.

Further, information SubFolderPath about the path of a folder in which certificates are stored may be included in the message.

Furthermore, the file length FileLength of the corresponding certificate may be included in the message.

Furthermore, the file name FileName of the corresponding certificate may be included in the message.

In this case, the DAC 420 may send the message CERTIFICATE_ISSUE_TRANSFER, which includes information about the certificate, along with an ACK message containing the result of transmitting the certificate, to the CAC 410.

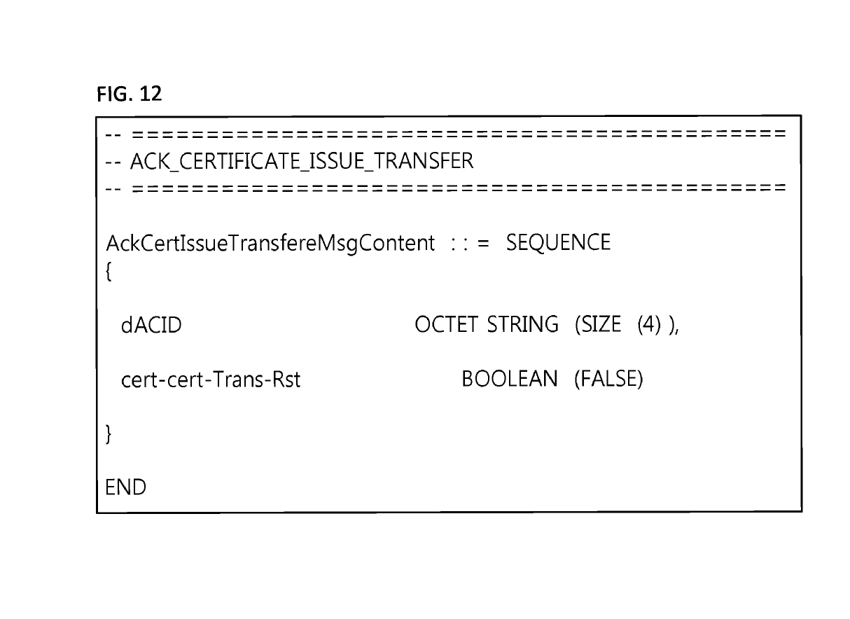

The ACK message containing the result of transmitting the certificate is illustrated in FIG. 12.

Referring to FIG. 12, the identifier of the DAC (DACID) and the result (CERT_CERT_TRANS_RST) of transmitting the certificate are contained in the ACK message.

Here, the ACK message may be sent only when the value of NEXTFLAG, among the flags included in a message including information about the certificate, is “FALSE”.

For example, when the number of messages sent from the CAC 410 is 10, the DAC receives a message CERTIFICATE_ISSUE_TRANSFER and a certificate file ten times. In this case, when the value of NEXTFLAG of the last message is “FALSE”, it is determined that even the last file has been received, and an ACK message, containing the result of transmitting certificates, is sent.

All of the messages illustrated in FIGS. 5 to 12 are messages defined in ASN.1 syntax.

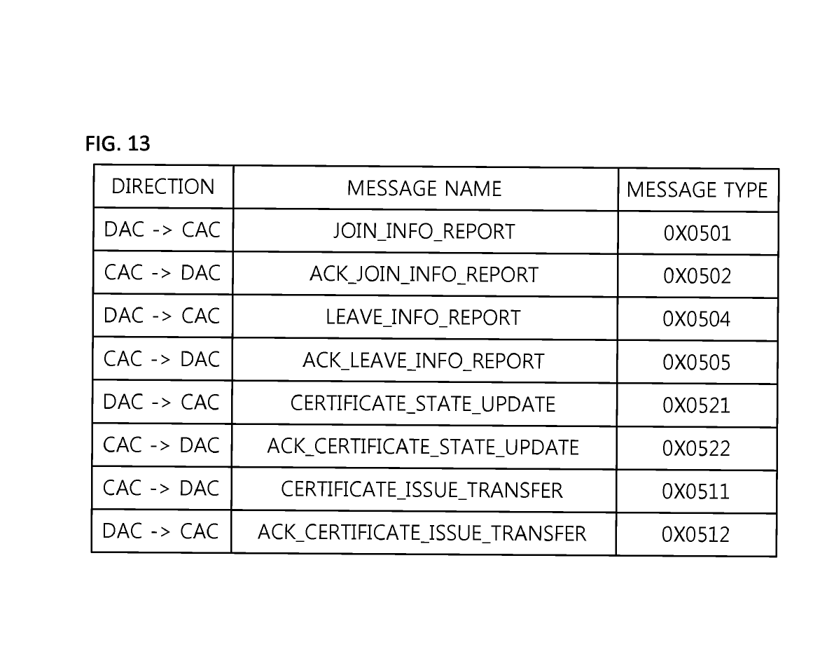

FIG. 13 is a diagram showing the types of messages used in the RCAS according to an embodiment of the present invention.

Referring to FIG. 13, it can be seen that message types are differently set depending on the directions in which messages are sent and the names of the messages.

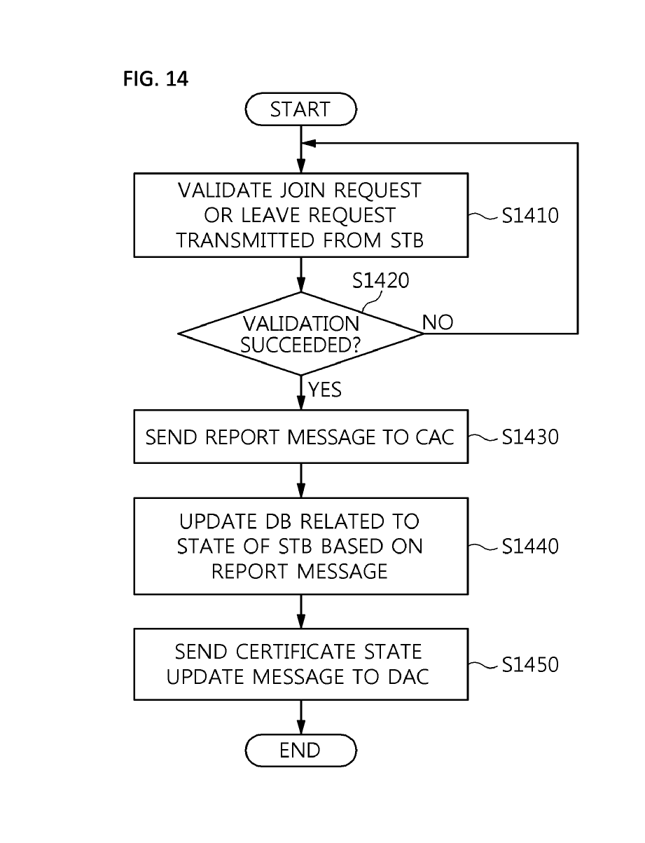

FIG. 14 is an operation flowchart showing a request processing method for the RCAS according to an embodiment of the present invention.

Referring to FIG. 14, a Distributed Authorization Center (DAC) validates a join request or a leave request transmitted from a Set-Top Box (STB) at step 51410.

Further, when validation has succeeded at step S1420, the DAC sends a report message to the CAC at step 51430.

Here, as the report message, a report message JOIN_INFO_REPORT, which is sent when the join request is successfully validated, and a report message LEAVE_INFO_REPORT, which is sent when the leave request is successfully validated, may differ from each other.

The respective report messages have been described with reference to FIGS. 5 to 8.

The CAC may send an ACK message to the report message to the DAC.

Here, the ACK message may contain data about the result of processing the join request, based on the report message for the join request JOIN_INFO_REPORT.

Further, the ACK message may contain data about the result of processing the leave request, based on the report message for the leave request LEAVE INFO REPORT.

The respective ACK messages have been described with reference to FIGS. 6 and 8.

Further, the CAC updates the DB related to the state of the STB based on the report message at step S1440.

Then, the CAC sends a certificate state update message including information about the update to the DAC of at least one additional head-end at step S1450.

Here, the information about the update may include an update query for the DB. A detailed description of the certificate state update message has been described with reference to FIG. 9.

Here, the DAC may further perform the step of synchronizing the information about the STB with the CAC, based on the certificate state update message.

Further, the DAC may send an ACK message containing the result of synchronization to the CAC. The ACK message containing the result of synchronization has been described with reference to FIG. 10.

The request processing method for the RCAS according to the present invention may be implemented as a program that can be executed by various computer means. In this case, the program may be recorded on a computer-readable storage medium. The computer-readable storage medium may include program instructions, data files, and data structures, either solely or in combination. Program instructions recorded on the storage medium may have been specially designed and configured for the present invention, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as compact disk (CD)-read only memory (ROM) and a digital versatile disk (DVD), magneto-optical media, such as a floptical disk, ROM, random access memory (RAM), and flash memory. Examples of the program instructions include machine language code, such as code created by a compiler, and high-level language code executable by a computer using an interpreter. The hardware devices may be configured to operate as one or more software modules in order to perform the operation of the present invention, and vice versa.

As described above, the present invention defines content to be inserted into the payload of a message in an ASN.1 format, in messages delivered between a DAC and a CAC in an RCAS, thus enabling the RCAS to be effectively operated.

As described above, in the RCAS and the request processing method for the RCAS according to the present invention, the configurations and schemes in the above-described embodiments are not limitedly applied, and some or all of the above embodiments can be selectively combined and configured so that various modifications are possible.

What is claimed is:

1. A request processing method for a Renewable Conditional Access System (RCAS) including head-ends, comprising:
validating, by a Distributed Authorization Center (DAC), a join request or a leave request transmitted from a Set-Top Box (STB);
sending, by the DAC, a report message to a Centralized Authorization Center (CAC) when validation has succeeded;
updating, by the CAC, a database (DB) related to a state of the STB, based on the report message; and
sending a certificate state update message including information about the update to DACs of one or more additional head-ends.

2. The request processing method of claim 1, wherein sending the report message to the CAC comprises:
sending a report message to the CAC when the join request is successfully validated, the report message including a DAC identifier of the DAC, a Conditional Access Module Sub-system (CASS) identifier of a CASS, a Conditional Access Module (CAM) identifier of a CAM of the STB, and a descrambler identifier of a descrambler of the STB.

3. The request processing method of claim 2, further comprising:
sending, by the CAC, an acknowledgement message, in response to the report message, to the DAC.

4. The request processing method of claim 3, wherein the acknowledgement message includes data about a result of processing the join request by the CAC, based on the report message for the join request.

5. The request processing method of claim 1, wherein sending the report message to the CAC comprises:
sending a report message to the CAC when the leave request is successfully validated, the report message including a DAC identifier of the DAC, a CASS identifier of a CASS, a CAM identifier of a CAM of the STB, and a descrambler identifier of a descrambler of the STB.

6. The request processing method of claim 5, further comprising sending, by the CAC, an acknowledgement message for the leave request to the DAC.

7. The request processing method of claim 6, wherein the acknowledgement message for the leave request includes data about a result of processing the leave request by the CAC, based on the report message for the leave request.

8. The request processing method of claim 1, wherein the information about the update comprises at least one parameter that includes an update query of the database.

9. The request processing method of claim 8, further comprising:
synchronizing, by the DAC, information about the STB with the CAC, based on the certificate state update message.

10. The request processing method of claim 9, further comprising:
sending, by the DAC, an acknowledgement message including a result of synchronization to the CAC.

11. A request processing method for a Renewable Conditional Access System (RCAS) including head-ends, comprising:
requesting, by a Distributed Authorization Center (DAC), a Centralized Authorization Center (CAC) to generate a certificate of a Set-Top Box (STB); and
generating, by the CAC, the certificate, and sending both the certificate and a message including information about the certificate to the DAC.

12. The request processing method of claim 11, wherein the message including information about the certificate includes at least one of information about whether there is an additional certificate to be transmitted from the CAC to the DAC, information about a path of a folder in which certificates are stored, a length of each certificate, and a file name of the certificate.

13. The request processing method of claim 12, further comprising:
sending, by the DAC, an acknowledgement message including a result of transmitting the certificate to the CAC, based on the message including the information about the certificate.

14. The request processing method of claim 13, wherein sending the acknowledgement message to the CAC comprises:
determining, by the CAC, whether transmission of the certificate has been completed, based on information about whether there is an additional certificate to be transmitted to the DAC, and sending the acknowledgement message to the CAC if it is determined that the transmission of the certificate has been completed.

15. A Renewable Conditional Access System (RCAS) including head-ends, comprising:
a Distributed Authorization Center (DAC) for validating a join request or a leave request transmitted from a Set Top Box (STB), and sending a report message to a Centralized Authorization Center (CAC) when validation has succeeded; and
the CAC for updating a database related to a state of the STB, based on the report message, and sending a certificate state update message including information about the update to DACs of one or more additional head-ends.

16. The RCAS of claim 15, wherein the DAC sends a report message to the CAC when the join request is successfully validated, the report message including a DAC identifier of the DAC, a Conditional Access Module Sub-system (CASS) identifier of a CASS, a CAM identifier of a CAM of the STB, and a descrambler identifier of a descrambler of the STB.

17. The RCAS of claim 16, wherein the CAC sends an acknowledge message, in response to the report message, to the DAC.

18. The RCAS of claim 17, wherein the CAC sends the acknowledgement message including data obtained by processing the join request based on the report message for the join request.

19. The RCAS of claim 18, wherein each of the report message and the acknowledgement message is defined in an Abstract Syntax Notation One (ASN.1) syntax format.

20. The RCAS of claim 19, wherein the report message and the acknowledgement message have different message type values depending on names of the messages and directions in which the messages are sent.
